(19) United States
(12) Patent Application Publication
(10) Pub. No.: US 2025/0172654 A1
(43) Pub. Date: May 29, 2025

(54) ON-DEMAND JOINT POSITIONING AND SENSING IN CELLULAR SYSTEMS

(71) Applicant: QUALCOMM Incorporated, San Diego, CA (US)

(72) Inventors: Weimin DUAN, San Diego, CA (US); Bala RAMASAMY, San Marcos, CA (US)

(21) Appl. No.: 18/521,932

(22) Filed: Nov. 28, 2023

(51) Int. Cl. G01S 7/00; G01S 7/41; H04W 64/00

(52) U.S. Cl. CPC G01S 7/006; G01S 7/411; G01S 7/415; H04W 64/00

(57) ABSTRACT

An example method for on-demand joint positioning and sensing a User Equipment (UE), the method performed by the UE and comprising determining a triggering event for radio frequency (RF) sensing of a target; responsive to the triggering event, determining a first request for the RF sensing of the target, determining identification information of the target, and transmitting to a server, the first request along with the identification information of the target.

### BACKGROUND

### 1. Field of Disclosure

The present disclosure relates generally to the field of wireless communications, and more specifically to on-demand joint positioning and sensing in a cellular network.

### 2. Description of Related Art

As the sophistication of cellular networks such as fourth-generation (4G) and fifth-generation (5G) cellular networks continues to increase, the functionality of such networks expands beyond mere data communication. Cellular networks can, for example, provide positioning functionality to determine a geographical location of a cellular mobile device (known as a “user equipment” (UE)) within a coverage region of the cellular network. Further, such networks are expanding into radio frequency (RF) sensing to be able to detect the objects (including their location and speed) from reflections (or echoes) of RF signals off of the objects.

### BRIEF SUMMARY

An example method for on-demand joint positioning and sensing a User Equipment (UE), the method performed by the UE and comprising determining a triggering event for radio frequency (RF) sensing of a target; responsive to the triggering event, determining a first request for the RF sensing of the target, determining identification information of the target, and transmitting to a server, the first request along with the identification information of the target.

An example for on-demand joint positioning and sensing a User Equipment (UE), the method performed by a server and comprising receiving a first request for radio frequency (RF) sensing of a target and identification information of the target, wherein the target is co-located with the UE, and wherein the first request is transmitted responsive to a triggering event determined by the UE, determining a RF sensing configuration for RF sensing the target, and transmitting to one or more base stations the RF sensing configuration for sensing the target.

An example User Equipment (UE) for on-demand joint positioning and sensing the UE comprising one or more transceivers, one or more memories, and one or more processors communicatively coupled with the one or more transceivers and the one or more memories. The one or more processors are configured to determine a triggering event for radio frequency (RF) sensing of a target; responsive to the triggering event, determine a first request for the RF sensing of the target, determine identification information of the target, and transmit to a server, the first request along with the identification information of the target.

An example server for on-demand joint positioning and sensing a User Equipment (UE) comprising: one or more transceivers, one or more memories, and one or more processors communicatively coupled with the one or more transceivers and the one or more memories. The one or more processors are configured to receive a first request for radio frequency (RF) sensing of a target and identification information of the target, wherein the target is co-located with the UE, and wherein the first request is transmitted responsive to a triggering event determined by the UE, determine a RF sensing configuration for RF sensing the target, and transmit to one or more base stations the RF sensing configuration for sensing the target.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a communication/positioning/sensing system, according to an embodiment.

FIG. 2 shows a diagram of a 5G New Radio (NR) network 200, illustrating an embodiment of a wireless system (e.g., communication/positioning/sensing system 100) implemented in 5G NR.

FIG. 3 is a diagram of an architecture 300 used to perform RF sensing, according to embodiments herein.

FIG. 4 is a call flow diagram for a general method of on-demand active positioning, according to some embodiments.

FIG. 5 is a call flow diagram for an example method of on-demand passive positioning, according to an embodiment.

FIG. 6 is a flow diagram of an example method of on-demand joint positioning and sensing a UE, performed by the UE, according to an embodiment.

FIG. 7 is a flow diagram of an example method of on-demand joint positioning and sensing a UE, performed by a server, according to an embodiment.

FIG. 8 is a block diagram of an embodiment of a UE.

FIG. 9 is a block diagram of an embodiment of a computer system.

Like reference symbols in the various drawings indicate like elements, in accordance with certain ex ample implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a NR network. As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

Yet, unless otherwise specified, the term “active positioning” as used herein may be used to refer to determining the position estimate of the UE based on the UE actively transmitting and/or receiving position reference signal(s) (PRSs). The term “passive positioning” as used herein may be used to refer to determining the position estimate of the UE based on an RF sensing result of a target identified by the UE.

A location service (e.g., positioning of a UE) can be enabled either through a single technique (e.g., Global Navigation Satellite System (GNSS), NR UE positioning, 5G/6G RF sensing, or other Radio Access Technology (RAT)-independent positioning methods) or by jointly using multiple techniques. From the perspective of the UE, there is always a trade-off among performance, privacy, and power consumption. These considerations and/or conditions could guide the design principles of location/positioning for the UE. Particular aspects of the subject matter described in this disclosure can be implemented to realize flexible switching between different positioning modes (e.g., active positioning and passive positioning) based on use cases, user's considerations, and/or the UE's conditions. Furthermore, the proposed scheme could unify multiple techniques in 3GPP, such as 5G or 6G cellular network UE positioning and 6G cellular network RF sensing, potentially triggering cloud-based location services for new business opportunities.

Various aspects generally relate to the field of RF-based sensing in a wireless network. Some aspects more specifically relate to a UE being able to switch to and perform passive positioning responsive to a triggering event (e.g., in certain conditions and/or having considerations, such as having a low power status or privacy concerns). In some examples, responsive to the triggering event, a UE may perform passive positioning by requesting RF sensing of a target that is co-located with the UE (e.g., transmitting the request to a location server and/or a sensing server). The request may be transmitted along with identification information of the target. Accordingly, instead of based on active positioning, where the UE actively transmits and/or receives PRSs, a location estimate may be determined based on passive positioning, where a location estimate may be determined according to the sensing result of the target. Therefore, the user's special needs (e.g., saving battery) and/or considerations (e.g., protecting user privacy) may be addressed.

Various advantages may be realized by performing the technical solution disclosed herein. For example, to further reduce the device resource (e.g., communication resources, processing capabilities, battery power, etc.) consumption at the UE and/or better protect privacy, an on-demand passive positioning may be introduced. Specifically, responsive to a triggering event (e.g., in certain conditions and/or having considerations, such as having a low power status or privacy concerns), a UE may request RF sensing of a target that is co-located with the UE (e.g., transmit the request to a location server and/or a sensing server). The request may be transmitted along with identification information of the target. Accordingly, instead of based on active positioning, where the UE actively transmits and/or receives PRSs, a location estimate may be determined based on passive positioning, where a location estimate may be determined according to the sensing result of the target. Therefore, the user's special needs (e.g., saving battery) and/or considerations (e.g., protecting user privacy) may be addressed.

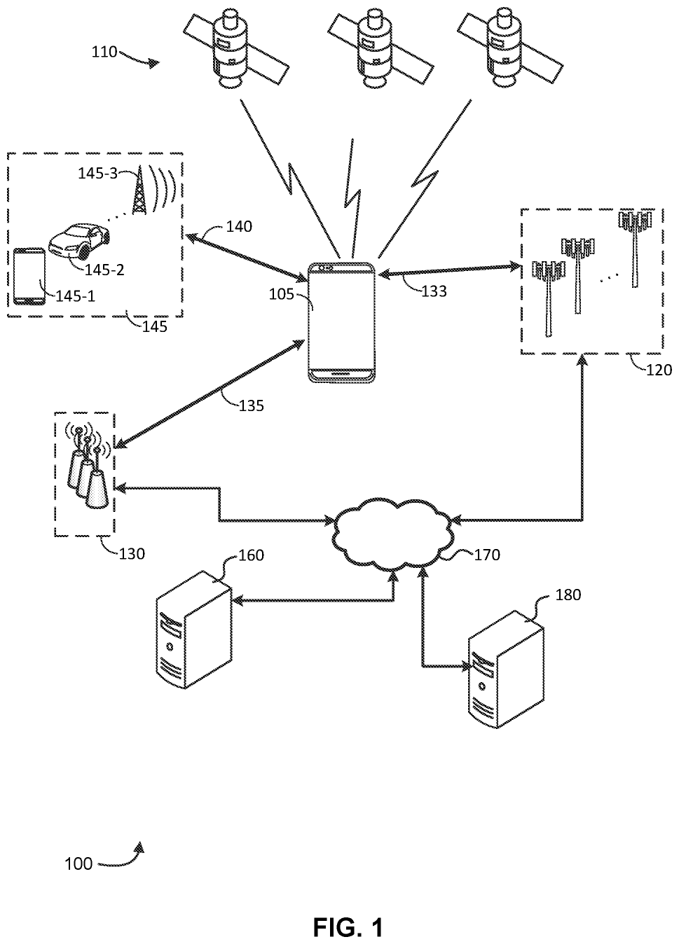

FIG. 1 is a simplified illustration of a wireless system capable of communication, positioning, and sensing, referred to herein a as “communication/positioning/sensing system” 100 in which a mobile device 105, network function server 160, and/or other components of the communication/positioning/sensing system 100 can use the techniques provided herein for RF sensing and/or positioning, according to an embodiment. (That said, embodiments are not necessarily limited to such a system.) The techniques described herein may be implemented by one or more components of the communication/positioning/sensing system 100. The communication/positioning/sensing system 100 can include: a mobile device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and or Non-Terrestrial Network (NTN) satellites; base stations 120; access points (APs) 130; network function server 160; network 170; and client external 180. Generally put, the communication/positioning/sensing system 100 may be capable of enabling communication between the mobile device 105 and other devices, positioning of the mobile device 105 and/or other devices, performing RF sensing by the mobile device 105 and/or other devices, or a combination thereof. For example, the communication/positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the communication/positioning/sensing system 100. Similarly, the communication/positioning/sensing system 100 may include a larger or smaller number of base stations 120 and/or APs 130 than illustrated in FIG. 1. The illustrated connections that connect the various components in the communication/positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to network function server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In and LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as network function server 160, by accessing the network 170 via a base station 120 using a first communication link 133. Additionally or alternatively, because APs 130 also may be communicatively coupled with the network 170, mobile device 105 may communicate with network-connected and Internet-connected devices, including network function server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

Satellites 110 may be utilized for positioning in communication in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

The network function server 160 may comprise one or more servers and/or other computing devices configured to provide a network-managed and/or network-assisted function, such as operating as a location server and/or sensing server. A location server, for example, may determine an estimated location of mobile device 105 and/or provide data (e.g., “assistance data”) to mobile device 105 to facilitate location measurement and/or location determination by mobile device 105. According to some embodiments, a location server may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in the location server. In some embodiments, the location server may comprise, a Discovered SLP (D-SLP) or an Emergency SLP (E-SLP). The location server may also comprise an Enhanced Serving Mobile Location Center (E-SMLC) that supports location of mobile device 105 using a control plane (CP) location solution for LTE radio access by mobile device 105. The location server may further comprise a Location Management Function (LMF) that supports location of mobile device 105 using a control plane (CP) location solution for NR or LTE radio access by mobile device 105.

Similarly, the network function server 160, may function as a sensing server. A sensing server can be used to coordinate and/or assist in the coordination of sensing of one or more objects (also referred to herein as “targets”) by one or more wireless devices in the communication/positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

An estimated location of mobile device 105 can be used in a variety of applications—e.g., to assist direction finding or navigation for a user of mobile device 105 or to assist another user (e.g., associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g., latitude, longitude and optionally altitude), relative (e.g., relative to some known absolute location) or local (e.g., X, Y and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which mobile device 105 is expected to be located with some level of confidence (e.g., 95% confidence).

The external client 180 may be a web server or remote application that may have some association with mobile device 105 (e.g., may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc. As previously noted, the example communication/positioning/sensing system 100 can be implemented using a wireless communication network, such as an LTE-based or 5G NR-based network, or a future 6G network.

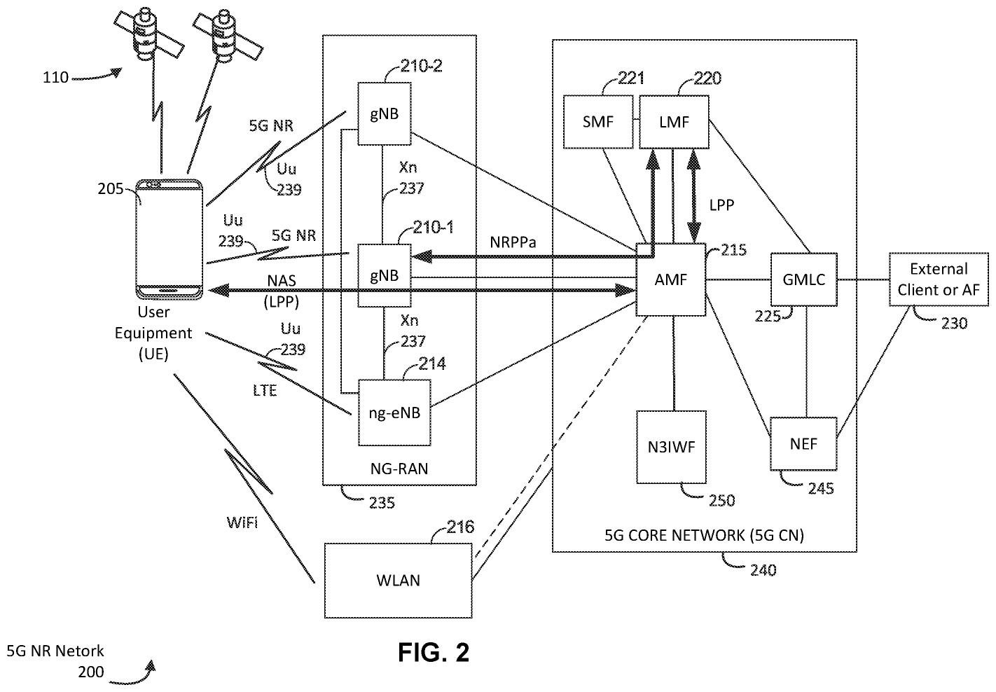

As previously noted, the example communication/positioning/sensing system 100 can be implemented using a wireless communication network, such as an LTE-based or 5G NR-based network, or a future 6G network. FIG. 2 shows a diagram of a 5G NR network 200, illustrating an embodiment of a wireless system (e.g., communication/positioning/sensing system 100) implemented in 5G NR. The 5G NR network 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR network 200 additionally may be configured to determine the location of a UE 205 by using an LMF 220 (which may correspond with location server 160) to implement the one or more positioning methods. The SMF 221 may coordinate RF sensing by the 5G NR network 200. Here, the 5G NR network 200 comprises a UE 205, and components of a 5G NR network comprising a Next Generation (NG) Radio Access Network (RAN) (NG-RAN) 235 and a 5G Core Network (5G CN) 240. A 5G NR network 200 may also be called a 5G network and/or an NR network; NG-RAN 235 may be referred to as a 5G RAN or as an NR RAN; and 5G CN 240 may be referred to as an NG Core network. Additional components of the 5G NR network 200 are described below. The 5G NR network 200 may include additional or alternative components.

The 5G NR network 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR network 200. Similarly, the 5G NR network 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR network 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAXTM), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR network 200, such as the LMF 220 and AMF 215.

5G NR network 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR network 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhanced Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

As mentioned above, cellular networks such as 5G NR cellular networks can be used to determine the position of wireless devices, such as UEs and are expanding into RF sensing to be able to detect objects (including their location, range, and speed) from reflections (or echoes) of RF signals reflecting from the objects. It is noted that when performing the RF sensing, the network entities mentioned above may be reused with the physical layer procedure being replaced by RF sensing operations.

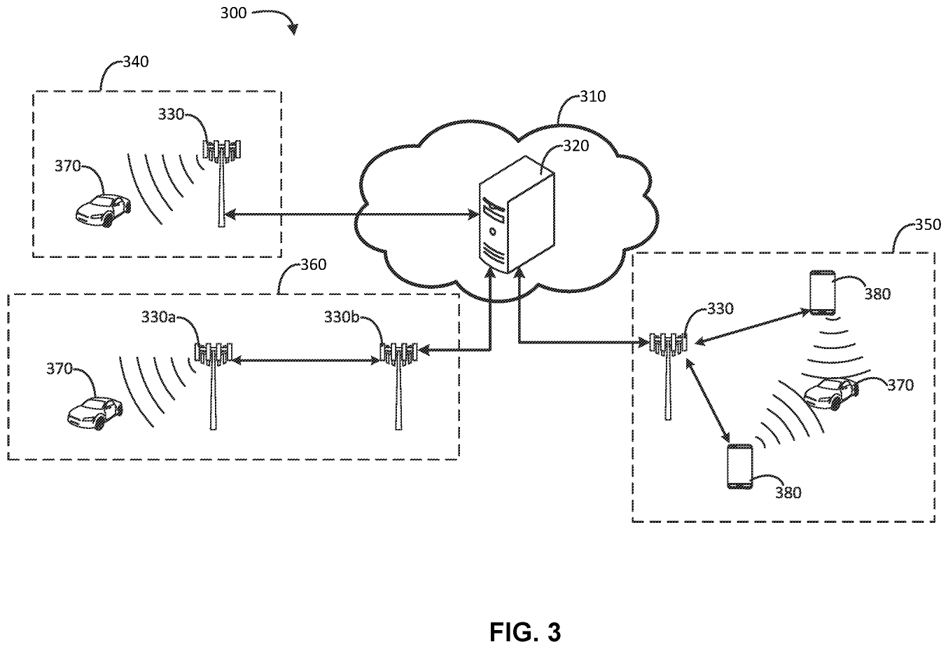

FIG. 3 is a diagram of an architecture 300 used to perform RF sensing, according to embodiments herein. Components include a network 310 comprising a sensing server 320, which is in communication with one or more base stations 330. The architecture 300 further illustrates different configurations 340, 350, and 360 for RF sensing, any or all of which may be utilized in a given embodiment. In a first configuration 340, a base station 330 acts as a sensing node to perform sensing of a target 370. (Although illustrated as vehicles, targets 370 may comprise any objects detectable via RF sensing.) In a second configuration 350, a base station 330 is in communication with other devices 380 (e.g., mobile devices or other wireless devices), which act as sensing nodes to perform sensing of a target 370. In a third configuration 360, a first base station 330a acts as a sensing node to perform sensing of a target 370, and a second base station 330b acts as a accessing point for the first base station 330a, enabling communications between the first base station 330a and the sensing server 320.

Although three configurations 340, 350, and 360 are provided in FIG. 3, additional or alternative configurations (e.g., using other mobile devices/UEs or other wireless devices as sensing nodes) may be utilized. More broadly, depending on desired functionality, any combination of base stations 330 and/or other devices 380 may act as sensing nodes to perform sensing of a target 370. As such, sensing nodes may comprise base stations 330 and/or other devices 380. The base stations 330 may additionally or alternatively act as accessing nodes to sensing nodes (other devices 380 and/or base stations 330). Again, RF sensing may be implemented by sensing nodes using monostatic, bistatic, and/or multi-static sensing.

In FIG. 3, the architecture 300 may correspond with aspects of the communication/positioning/sensing system 100 of FIG. 1 and the 5G NR network 200 of FIG. 2 related to RF sensing. For example, the sensing server 320 may correspond to a network function server 160 of FIG. 1 (e.g., an SMF) and/or an SMF 221 of FIG. 2. Network 310 may correspond with network 170 (e.g., a 5G or 6G cellular network) of FIG. 1 and/or the 5G NR network 200 of FIG. 2. Base stations 330 may correspond with base stations 120, the gNBs 210 and/or the ng-eNB 214, and other devices 380 may correspond with wireless devices in FIG. 1 or 2 (e.g., mobile device 105, UE 205, mobile devices 145, APs 130, satellites 110, or any combination thereof). Thus, the architecture 300 may be implemented by a communication/positioning/sensing system 100, a 5G NR network 200, and/or another system capable of enabling wireless communication and/or wireless positioning.

Broadly put, the sensing server 320, may comprise a server executed in the network 310 to implement RF sensing. As such, the sensing server 320 may be responsible for the overall sensing management, including the sensing configuration and the processing for detection of targets 370. For example, the sensing server 320 may coordinate with one or more base stations 330 to configure the sensing resources to the sensing nodes. The sensing server 320 may additionally or alternatively trigger the sensing nodes to perform RF sensing, receive reporting from each of the sensing nodes, collect the sensing reporting from the sensing nodes, detect/identify/track targets based on the sensing reporting, or any combination thereof. Sensing nodes may perform the sensing actions, including transmission and/or reception of sensing RS, and report the sensing information (e.g., measurements of sensing RS and/or information derived therefrom, such as extracted feature information and/or target information like location, speed, etc.). Performing the sensing actions and/or reporting of the sensing information may be in accordance with the sensing configuration received from the sensing server 320. Base stations 330 may act as sensing nodes and/or may act as access points to convey information between location server 320 and sensing nodes (e.g., other devices 380). This may include conveying configuration information from location server 320 to sensing nodes and/or conveying sensing information (reporting) from sensing nodes to location server 320.

As noted above, the functionality of cellular networks such as 4G and 5G cellular networks expands from mere data communication to positioning and sensing. Compared with conventional active positioning (e.g., according to always-on PRS configurations, specified in e.g., Release 16 specification), where the PRS (e.g., the DL-PRS) is statically configured and is transmitted continuously by the network, active positioning according to on-demand PRS configurations, where the PRS or resources for positioning are provided and/or configured dynamically when requested by a UE or LMF, may reduce the resource overhead and the energy consumption, and may improve the resource allocation efficiency. For example, according to the on-demand PRS configuration, a temporary increase or decrease of the PRS resources may be allowed to meet different positioning accuracy and/or latency requirements in certain areas or at certain times.

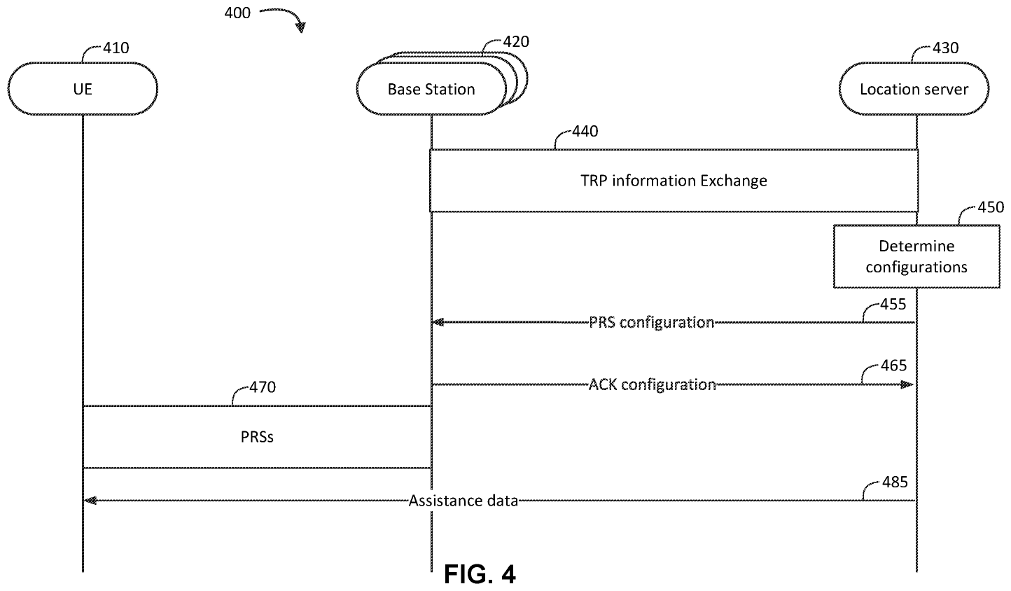

FIG. 4 is a call flow diagram for a general method of on-demand active positioning 400, according to an embodiment. In FIG. 4, the architecture for performing the on-demand active positioning 400 may correspond with aspects of the communication/positioning/sensing system 100 of FIG. 1 and the 5G NR network 200 of FIG. 2 related to PRS-based positioning. Here, messaging takes place between a UE 410 (e.g., a mobile device 105, a UE 205, or mobile devices 145), one or more base stations 420 (e.g., base stations 120, NG-RAN 235, gNBs 210 and/or ng-eNBs 214), and a location server 430 (e.g., network function server 160, and may include a LMF 220 and an AMF 215). Communications between the UE 410 and the location server 430 may be relayed by the base stations 420 (and, in some embodiments, other intervening devices that are not shown in FIG. 4).

Starting at block 440, the initial information may be exchanged between the one or more base stations 420 and the location server 430 (e.g., the AMF). The initial information may include TRP information including the on-demand PRS parameters (e.g., resource set periodicity, PRS bandwidth, resource repetition factor, resource number of symbols, Comb size, number of frequency layers, start time and duration, off indication, Quasi-Co-Location (QCL) information) supported by the one or more base stations 420. Additionally or alternatively, the on-demand active positioning 400 may be initiated by the location server 430 (e.g., the LMF) to request the one or more base stations 420 to configure or update the PRS configuration.

At block 450, the one or more base stations 420 for performing the positioning and the PRS configuration are determined. For example, after receiving the initial information from the one or more base stations 420, the location server 430 (e.g., the AMF) may determine the appropriate base stations and the configurations for the PRS.

At arrow 455, a PRS configuration request may be transmitted from the location server 430 to the one or more base stations 420, indicating the PRS configuration (e.g., the requested PRS transmission parameters and the PRS transmission Off information).

At arrow 465, a PRS configuration response may be transmitted from the one or more base stations 420 back to the location server 430, indicating if the one or more base stations 420 may support the PRS configuration (e.g., transmitting acknowledgment (ACK) of the PRS configuration).

At block 470, the PRS may be communicated between the one or more base stations 420 and the UE 410 in accordance with the determined PRS configuration.

At arrow 485, the location server 430 (e.g., the LMF) may provide assistance data (e.g., information for aiding location estimation) to the UE 410.

It is understood that the on-demand active positioning 400 disclosed herein is one example implementation of the on-demand active positioning process. Any other suitable implementations may be applied. That said, embodiments are not necessarily limited to such a process.

To further reduce the device resource (e.g., communication resources, processing capabilities, battery power, etc.) consumption at the UE and/or better protect privacy, an on-demand passive positioning may be introduced. Specifically, responsive to a triggering event (e.g., in certain conditions and/or having considerations, such as having a low power status or privacy concerns), a UE may request RF sensing of a target that is co-located with the UE (e.g., transmit the request to a location server and/or a sensing server). The request may be transmitted along with identification information of the target. Accordingly, instead of based on active positioning, where the UE actively transmits and/or receives PRSs, a location estimate may be determined based on passive positioning, where a location estimate may be determined according to the sensing result of the target. Therefore, the user's special needs (e.g., saving battery) and/or considerations (e.g., protecting user privacy) may be addressed.

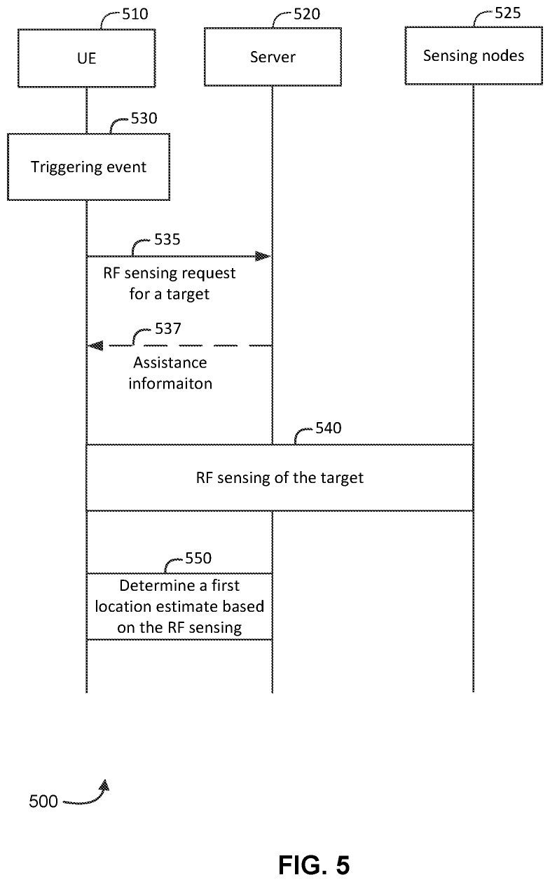

FIG. 5 is a call flow diagram for an example method of on-demand passive positioning 500, according to an embodiment. In FIG. 5, the architecture for performing the on-demand passive positioning 500 may correspond with aspects of the communication/positioning/sensing system 100 of FIG. 1, the 5G NR network 200 of FIG. 2, the architecture 300 of FIG. 3, and the architecture for performing the on-demand active positioning 400 of FIG. 4, that are related to PRS-based positioning. Here, messaging may take place between a UE 510 (e.g., a mobile device 105, a UE 205, mobile devices 145, devices 380, or the UE 410), a server 520 (e.g., the network function server 160, the sensing server 320, or the location server 430), and one or more sensing nodes 525. As will be noted below, the one or more sensing nodes 525 may include one or more base stations (e.g., base stations 120, NG-RAN 235, gNBs 210 and/or ng-eNBs 214, base stations 330, or the one or more base stations 420) and other UEs (e.g., a mobile device 105, a UE 205, mobile devices 145, devices 380, or the UE 410). Communications between the UE 510, the server 520, and sensing nodes 525 may be relayed by some intervening devices (e.g., base stations or wireless devices in some embodiments) that are not shown in FIG. 5.

Starting from block 530, a triggering event for RF sensing of a target may be determined. In some embodiments, the triggering event may include but not limited to the UE 510 having a low battery power and/or privacy concerns of the UE 510 (e.g., concerns of location tracking, personal privacy invasion, data security, etc.).

At arrow 535, responsive to the triggering event, a request for the RF sensing of the target may be transmitted to the server 520. For example, the UE 510 may obtain identification information of the target, such as a location of the target (e.g., if the target is co-located with the UE 510, an absolute location of the target, and/or a relative location between the target and the UE 510), a speed of the target, a radar cross-section (RCS) of the target, or one or more physical characteristics (e.g., type, shape, material, etc.) of the target. The identification information of the target may be transmitted to the server 520 for identifying the target along with the RF sensing request.

At block 540, the RF sensing of the target may be configured and performed. For example, as noted above, the server 520 may configure the on-demand RF sensing of the target and may transmit the RF sensing configuration to the sensing nodes 525. As noted above, depending on the implementations, the sensing nodes 525 for determining the sensing result may include one or more base stations (e.g., base stations 120, NG-RAN 235, gNBs 210 and/or ng-eNBs 214, base stations 330, or the one or more base stations 420) and/or other UEs (e.g., a mobile device 105, a UE 205, mobile devices 145, devices 380, or the UE 410). In some embodiments, the sensing result of the target comprises a range estimation, an angle estimation, a speed estimation, a location estimation, or any combination thereof.

At block 550, a first location estimate of the UE 510 may be determined based on the RF sensing. For example, in cases where the UE 510 co-locates with the target (e.g., the target is a vehicle associated with the UE 510), the sensing information of the target could be re-used for on-demand passive positioning of the UE 510. Since the UE 510 does not need to actively transmit and/or receive the PRS and report PRS measurements, the device resource consumption may be reduced and data privacy and information security may be better protected.

In some embodiments, after receiving the request at arrow 535, server 520 may share assistance information for RF sensing of the target with the UE 510, as shown in arrow 537. The assistance information may include: (1) whether the network supports RF sensing, (2) the coverage of the RF sensing service (e.g., the coverage per target range and target RCS), (3) the Quality of Service (QOS) of the RF sensing service in a specific region (e.g., with respect to cell ID or zone ID), (4) whether the network supports RF sensing-based target localization, and if not, what sensing results could be provided, (5) the time window for the RF sensing service or the periodicity of the RF sensing service, (6) the restrictions on target speed for RF sensing (e.g., sensing a static or low-speed target may be challenging for some configurations), or any combination thereof.

In some embodiments, before performing or switching to the on-demand passive positioning 500, the UE may be performing the on-demand active positioning (e.g., actively transmitting and/or receiving PRSs). After obtaining the position estimate based on the sensing result of the target in accordance with the on-demand passive positioning 500 discussed herein, the UE 510 may be allowed to skip (e.g., cancel or terminate) the remaining PRS measurements (if there still are according to the previous on-demand active positioning configuration) to save device resources.

In some embodiments, to ensure consistent quality of positioning (e.g., accuracy), the network (e.g., the server) may request the UE performing on-demand passive positioning to periodically conduct active UE positioning (e.g., obtaining active positioning results by periodically communicating PRSs with one or more network nodes, such as base stations). For example, the network may request the UE to measure DL-PRS and/or transmit UL-PRS periodically (e.g., at a larger interval than ordinary active positioning configurations that do not perform jointly with the passive positioning, such as every 2 seconds) to obtain location estimates. Additionally or alternatively, the network may request the UE to report its location periodically (e.g., at a larger interval than ordinary active positioning configurations that do not perform jointly with the passive positioning, such as every 5 seconds). In some embodiments, the network may on-demand request UE to conduct active positioning (e.g., in response to determining that an accuracy level of the on-demand passive positioning result is lower than a predetermined threshold).

In some embodiments, the active positioning results may be used to determine accuracy (e.g., the bias) of the passive positioning results. For example, the active positioning results may be compared with the passive positioning results. In cases where the bias/deviation for the passive positioning results is larger than a predetermined threshold, to ensure the positioning accuracy, one or some of the following options may be taken. First, the UE (e.g., the UE 510) may request to switch from the passive positioning to the active positioning. In some embodiments, the remaining process for the passive poisoning (e.g., the remaining RF sensing operations) may be cancelled/terminated. Second, the server (e.g., server 520) may request the UE to switch from the passive positioning to the active positioning. In some embodiments, the remaining process for the passive poisoning (e.g., the remaining RF sensing operations) may be cancelled/terminated. Third, the UE (e.g., the UE 510) or the server (e.g., the server 520) may request the UE to switch to a hybrid positioning where the passive positioning and the active poisoning may be jointly performed (e.g., the RF sensing may be maintained while the UE may conduct the active UE positioning). For example, the location estimate of the UE may be determined based on both the RF sensing results and the measurements of the PRSs. In some embodiments, if the active poisoning is a UE-based positioning, the server may need to transmit the sensing results to the UE for the hybrid poisoning.

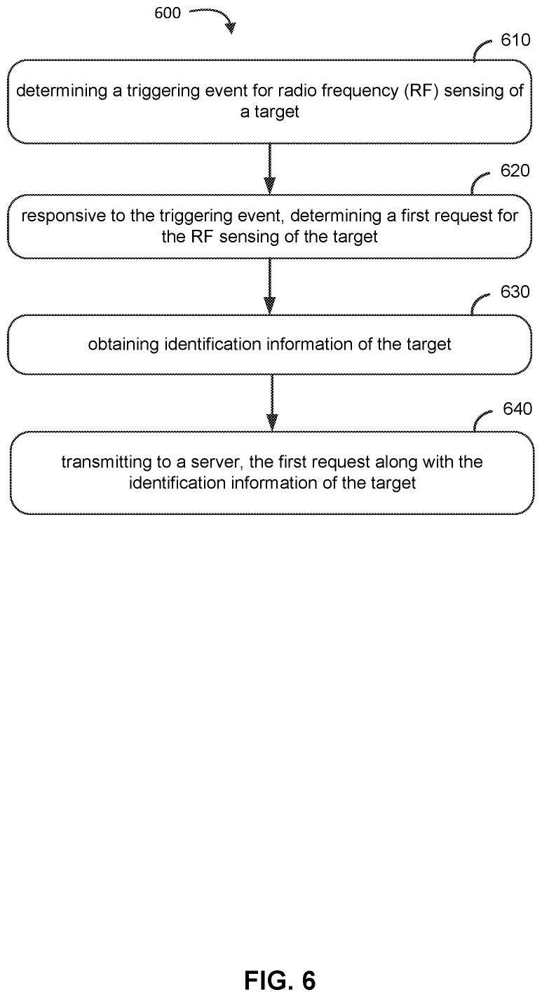

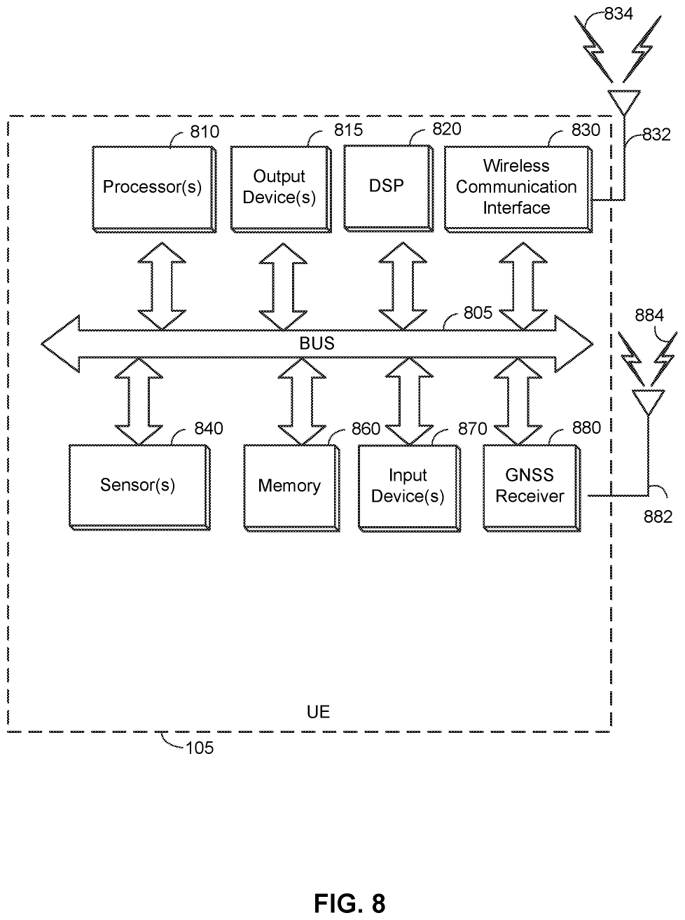

FIG. 6 is a flow diagram of an example method 600 of on-demand joint positioning and sensing a UE, performed by the UE, according to an embodiment. This functionality may reflect the functionality of the UE in the previously-described embodiments. As such, means for performing the functionality illustrated in one or more of the blocks shown in FIG. 6 may be performed by hardware and/or software components of a UE. Example components of a UE are illustrated in FIG. 8, which is described in more detail below.

At block 610, the functionality comprises determining a triggering event for radio frequency (RF) sensing of a target. As noted with respect to FIG. 5, this functionality may correspond to the functionality indicated at block 530 of FIG. 5, as described herein. As described in the embodiments herein, the triggering event may include but not limited to the UE having a low battery power and/or privacy concerns of the UE (e.g., concerns of location tracking, personal privacy invasion, data security, etc.).

Means for performing functionality at block 610 may comprise a bus 805, processor(s) 810, digital signal processor (DSP) 820, wireless communication interface 830, memory 860, and/or other components of a UE 105, as illustrated in FIG. 8.

At block 620, the functionality comprises responsive to the triggering event, determining a first request for the RF sensing of the target.

Means for performing functionality at block 620 may comprise a bus 805, processor(s) 810, digital signal processor (DSP) 820, wireless communication interface 830, memory 860, and/or other components of a UE 105, as illustrated in FIG. 8.

At block 630, the functionality comprises obtaining identification information of the target.

Means for performing functionality at block 630 may comprise a bus 805, processor(s) 810, digital signal processor (DSP) 820, wireless communication interface 830, memory 860, and/or other components of a UE 105, as illustrated in FIG. 8.

At block 640, the functionality comprises transmitting to a server, the first request along with the identification information of the target. As noted with respect to FIG. 5, this functionality along with the functionalities at blocks 620 and 630 may correspond to the functionality indicated at arrow 535 of FIG. 5, as described herein. As described in the embodiments herein, the UE may obtain identification information of the target, such as a location of the target (e.g., if the target is co-located with the UE, an absolute location of the target, and/or a relative location between the target and the UE), a speed of the target, a radar cross-section (RCS) of the target, or one or more physical characteristics (e.g., type, shape, material, etc.) of the target. The identification information of the target may be transmitted to the server for identifying the target along with the RF sensing request.

Means for performing functionality at block 630 may comprise a bus 805, processor(s) 810, digital signal processor (DSP) 820, wireless communication interface 830, memory 860, and/or other components of a UE 105, as illustrated in FIG. 8.

In some embodiments, after receiving the request, assistance information for RF sensing of the target may be received from the server as indicated in arrow 537 of FIG. 5. The assistance information may include: (1) whether the RF sensing is supported; (2) coverage of the RF sensing supported; (3) coverage per target range of the RF sensing; (4) target RCS of the RF sensing; quality of service (QOS) of the RF sensing; (5) types of sensing result supported; (6) whether RF sensing-based target localization is supported; a time window for the RF sensing; (7) periodicity of the RF sensing; (8) a speed of the target; or any combination thereof.

In some embodiments, the method 600 may further include functionalities that comprises configuring and performing the RF sensing of the target. As noted with respect to FIG. 5, the functionalities may correspond to the functionality indicated at block 540 of FIG. 5, as described herein. As described in the embodiments herein, the RF sensing of the target may be configured and performed. For example, as noted above, the server may configure the (on-demand) RF sensing of the target and may transmit the RF sensing configuration to the sensing nodes. As noted above, depending on the implementations, the sensing nodes may include one or more base stations (e.g., base stations 120, NG-RAN 235, gNBs 210 and/or ng-eNBs 214, base stations 330, or the one or more base stations 420) and/or other UEs (e.g., a mobile device 105, a UE 205, mobile devices 145, devices 380, or the UE 410). In other words, the sensing result of the target may be determined by one or more base stations and/or one or more other UEs. In some embodiments, the sensing result of the target comprises a range estimation, an angle estimation, a speed estimation, a location estimation, or any combination thereof.

Means for performing the functionality may comprise a bus 805, processor(s) 810, digital signal processor (DSP) 820, wireless communication interface 830, memory 860, and/or other components of a UE 105, as illustrated in FIG. 8.

In some embodiments, the method 600 may further include functionality that comprises determining a first location estimate based on the sensing result of the target. As noted with respect to FIG. 5, the functionality may correspond to the functionality indicated at block 550 of FIG. 5, as described herein. As described in the embodiments herein, a first location estimate of the UE may be determined based on the RF sensing. For example, in cases where the UE co-locates with the target (e.g., the target is a vehicle associated with the UE), the sensing information of the target could be re-used for on-demand passive positioning the UE. Since the UE does not need to actively transmit and/or receive the PRS and report PRS measurements, the device resource and data privacy and information security may also be better protected.

Means for performing the functionality may comprise a bus 805, processor(s) 810, digital signal processor (DSP) 820, wireless communication interface 830, memory 860, and/or other components of a UE 105, as illustrated in FIG. 8.

As noted above, in some embodiments, the server may include a sensing server, or both. In some embodiments, the UE may further be configured to communicate with one or more base stations PRSs to perform active positioning of the UE (e.g., obtain a second location estimate of the UE using measurements of the PRSs). In some embodiments, the second location of the UE is determined at a predetermined periodicity. In some embodiments, the second location of the UE is determined in response to a request from the server.

In some embodiments, the active positioning results may be used to determine accuracy (e.g., the bias) of the passive positioning results. For example, the active positioning results may be compared with the passive positioning results. In case where the bias/deviation for the passive positioning results (e.g., a difference between the passive poisoning results and the active positioning results are larger than a predetermined threshold, to ensure the positioning accuracy, one or some of the following options may be taken. First, the UE (e.g., the UE 510) may request to switch from the passive positioning to the active positioning. In some embodiments, the remaining process for the passive poisoning (e.g., the remaining RF sensing operations) may be cancelled/terminated (e.g., the UE may transmit a second request for terminating the RF sensing of the target). Second, the server (e.g., server 520) may request the UE to switch from the passive positioning to the active positioning. In some embodiments, the remaining process for the passive poisoning (e.g., the remaining RF sensing operations) may be cancelled/terminated. Third, the UE (e.g., the UE 510) or the server (e.g., the server 520) may determine to switch to a hybrid positioning where the passive positioning and the active poisoning may be jointly performed (e.g., the RF sensing may be maintained while the UE may conduct the active UE positioning). For example, the location estimate of the UE may be determined based on both the RF sensing results and the measurements of the PRSs. In some embodiments, if the active poisoning is a UE-based positioning, the server may need to transmit the sensing results to the UE for the hybrid poisoning.

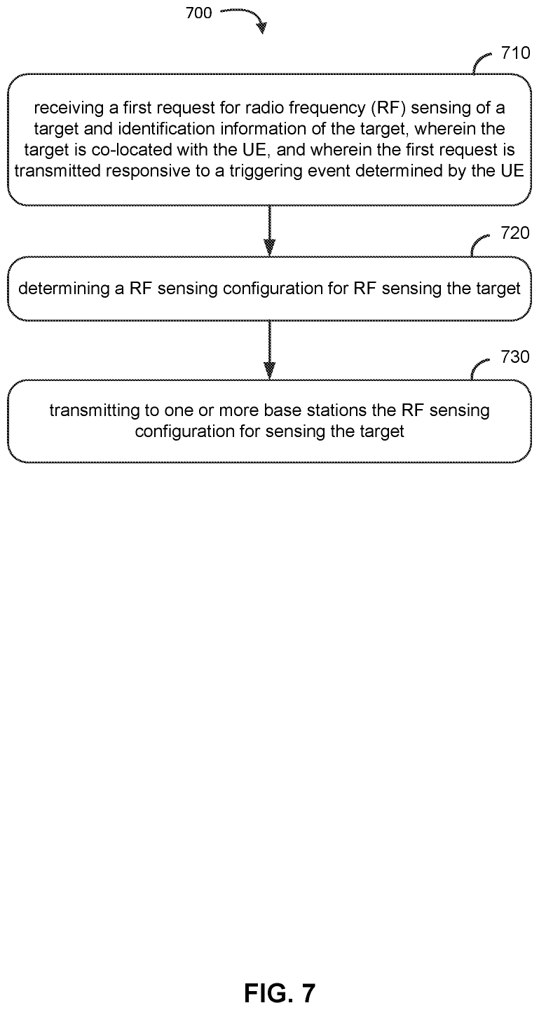

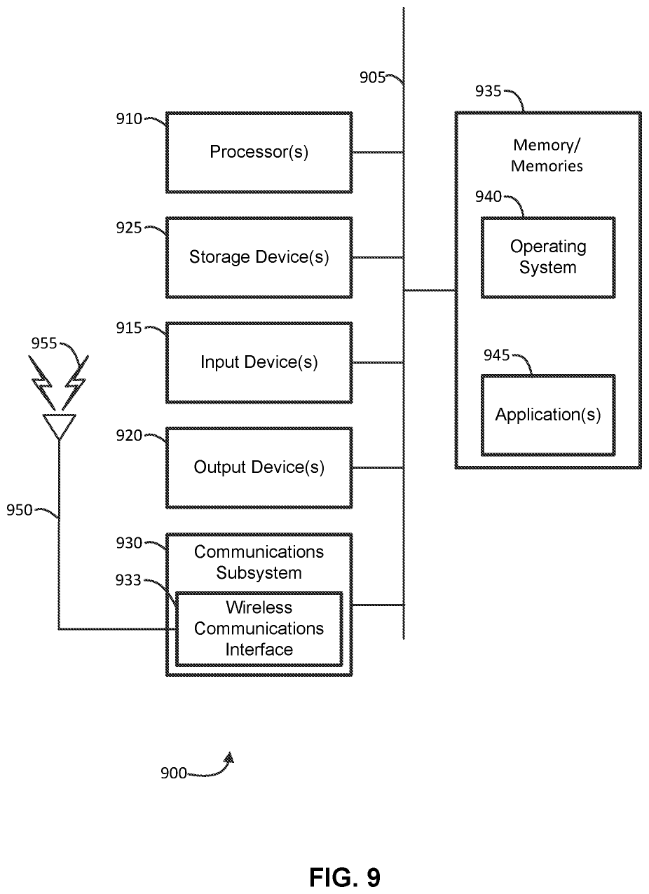

FIG. 7 is a flow diagram of a method 700 of on-demand joint positioning and sensing a UE, performed by a server, according to an embodiment. This functionality may reflect the functionality of the server in the previously-described embodiments. As such, means for performing the functionality illustrated in one or more of the blocks shown in FIG. 7 may be performed by hardware and/or software components of a computer system. Example components of a computer system are illustrated in FIG. 9, which is described in more detail below.

At block 710, the functionality comprises receiving a first request for radio frequency (RF) sensing of a target and identification information of the target, wherein the target is co-located with the UE, and wherein the first request is transmitted responsive to a triggering event determined by the UE. As noted with respect to FIG. 5, this functionality may correspond to the functionality indicated at block 530 of FIG. 5, as described herein. As described in the embodiments herein, the triggering event may include but not limited to the UE having a low battery power and/or privacy concerns of the UE (e.g., concerns of location tracking, personal privacy invasion, data security, etc.). In some embodiments, the identification information comprises a location of the target, a speed of the target, a radar cross-section (RCS) of the target, one or more physical characteristics of the target, or any combination thereof.

Means for performing functionality at block 710 may comprise a bus 905, processor(s) 910, communications subsystem 930, memory 935, and/or other components of a computer system 900, as illustrated in FIG. 9.

At block 720, the functionality comprises determining a RF sensing configuration for RF sensing the target.

Means for performing functionality at block 720 may comprise a bus 905, processor(s) 910, communications subsystem 930, memory 935, and/or other components of a computer system 900, as illustrated in FIG. 9.

At block 730, the functionality comprises transmitting to one or more base stations the RF sensing configuration for sensing the target. As noted with respect to FIG. 5, the functionalities may correspond to the functionality indicated at block 540 of FIG. 5, as described herein. As described in the embodiments herein, the RF sensing of the target may be configured and performed. For example, as noted above, the server may configure the (on-demand) RF sensing of the target and may transmit the RF sensing configuration to the sensing nodes. As noted above, depending on the implementations, the sensing nodes may include one or more base stations (e.g., base stations 120, NG-RAN 235, gNBs 210 and/or ng-eNBs 214, base stations 330, or the one or more base stations 420) and/or other UEs (e.g., a mobile device 105, a UE 205, mobile devices 145, devices 380, or the UE 410). In other words, the sensing result of the target may be determined by one or more base stations and/or one or more other UEs. In some embodiments, the sensing result of the target comprises a range estimation, an angle estimation, a speed estimation, a location estimation, or any combination thereof.

Means for performing functionality at block 730 may comprise a bus 905, processor(s) 910, communications subsystem 930, memory 935, and/or other components of a computer system 900, as illustrated in FIG. 9.

In some embodiments, the method 700 may further comprise obtaining a first location of the UE determined using a sensing result of the target. In some embodiments, the sensing result of the target is determined by another UE or at least one base station of the one or more base stations.

some embodiments, the method 700 may further comprise configuring the UE to communicate position reference signals (PRSs) and obtaining a second location of the UE based on measurements of the PRSs.

FIG. 8 is a block diagram of an embodiment of a UE 105, which can be utilized as described herein above (e.g., in association with FIGS. 1-7). For example, the UE 105 can perform one or more of the functions of the method shown in FIGS. 4-7. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 8.

The UE 105 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The UE 105 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The UE 105 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 830 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the UE 105, using conventional techniques, from GNSS satellites 110 of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 810 or DSP 820.

The UE 105 may further include and/or be in communication with a memory 860. The memory 860 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the UE 105 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the UE 105 (and/or processor(s) 810 or DSP 820 within UE 105). In some embodiments, then, such code and/or instructions can be used to configure and/or adapt a general-purpose computer (or other device) to perform one or more operations in accordance with the described methods.

FIG. 9 is a block diagram of an embodiment of a computer system 900, which may be used, in whole or in part, to provide the functions of one or more components and/or devices as described in the embodiments herein, including a server and/or services in the cloud. Thus, the computer system 900 may be utilized as and/or correspond with, for example, the network function server 160 in FIG. 1, the LMF 220 and the SMF 221 in FIG. 2, the sensing server 320 in FIG. 3, the location server 430 in FIG. 4, the server 520 in FIG. 5, and/or a cloud, server, and/or remote device, or any combination thereof, as described herein. The computer system 900 may perform one or more of the operations of method 700 illustrated in FIG. 7. The computer system 900 may include, for example, a computer server, personal computer, personal electronic device, or the like. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computer system 900 is shown comprising hardware elements that can be electrically coupled via a bus 905 (or may otherwise be in communication, as appropriate). The hardware elements may include processor(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 900 also may comprise one or more input devices 915, which may comprise without limitation a mouse, a keyboard, a camera, a microphone, and/or the like; and one or more output devices 920, which may comprise without limitation a display device, a printer, and/or the like.

The computer system 900 may further include (and/or be in communication with) one or more non-transitory storage devices 925, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 900 may also include a communications subsystem 930, which may comprise wireless communication technologies managed and controlled by a wireless communication interface 933, as well as wired technologies (such as Ethernet, coaxial communications, universal serial bus (USB), and the like). The wireless communication interface 933 may comprise one or more wireless transceivers that may send and receive wireless signals 955 (e.g., signals according to 5G NR or LTE) via wireless antenna(s) 950. Thus the communications subsystem 930 may comprise a modem, a network card (wireless or wired), an infrared communication device, a wireless communication device, and/or a chipset, and/or the like, which may enable the computer system 900 to communicate on any or all of the communication networks described herein to any device on the respective network, including a User Equipment (UE), base stations and/or other transmission reception points (TRPs), and/or any other electronic devices described herein. Hence, the communications subsystem 930 may be used to receive and send data as described in the embodiments herein.

In many embodiments, the computer system 900 will further comprise a working memory 935, which may comprise a RAM or ROM device, as described above. Software elements, shown as being located within the working memory 935, may comprise an operating system 940, device drivers, executable libraries, and/or other code, such as one or more applications 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general-purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. An example method for on-demand joint positioning and sensing a User Equipment (UE), the method performed by the UE and comprising determining a triggering event for radio frequency (RF) sensing of a target; responsive to the triggering event, determining a first request for the RF sensing of the target, determining identification information of the target, and transmitting to a server, the first request along with the identification information of the target.
Clause 2. The method of clause 1, wherein the server comprises a location server, a sensing server, or both.
Clause 3. The method of clause 1 or 2, wherein determining the identification information of the target comprises determining that the target is co-located with the UE.
Clause 4. The method of any of clauses 1-3, wherein the identification information comprises: a location of the target; a speed of the target; a radar cross-section (RCS) of the target; one or more physical characteristics of the target; or any combination thereof.
Clause 5. The method of any of clauses 1-4, further comprising: obtaining a first location of the UE determined using a sensing result of the target.
Clause 6. The method of any of clauses 1-5, wherein the sensing result of the target is determined by another UE.
Clause 7. The method of any clauses 1-6, wherein the sensing result of the target is determined by a base station.
Clause 8. The method of any of clauses 1-7, wherein a sensing result of the RF sensing of the target comprises: a range estimation; an angle estimation; a speed estimation; a location estimation; or any combination thereof.
Clause 9. The method of any of clauses 1-8, further comprising: communicating with one or more network nodes, position reference signals (PRSs).
Clause 10. The method of any of clauses 1-9, further comprising: obtaining a second location of the UE using measurements of the PRSs.
Clause 11. The method of any of clauses 1-10, wherein the second location of the UE is determined at a predetermined periodicity.
Clause 12. The method of any of clauses 1-11, wherein the second location of the UE is determined in response to a second request from the server.
Clause 13. The method of any of clauses 1-12, wherein responsive to a difference between the first location and the second location being larger than a predetermined threshold, the method further comprises: transmitting a second request for terminating the RF sensing of the target.
Clause 14. The method of any of clauses 1-13, wherein responsive to a difference between the first location and the second location being larger than a predetermined threshold, the method further comprises: determining a third location of the UE using the sensing result of the target and the measurements of the PRSs.
Clause 15. The method of any of clauses 1-14, further comprising: receiving from the server assistance information, wherein the assistance information comprises: whether the RF sensing is supported; coverage of the RF sensing supported; coverage per target range of the RF sensing; target RCS of the RF sensing; quality of service (QOS) of the RF sensing; types of sensing result supported; whether RF sensing-based target localization is supported; a time window for the RF sensing; periodicity of the RF sensing; a speed of the target; or any combination thereof.
Clause 16. An example for on-demand joint positioning and sensing a User Equipment (UE), the method performed by a server and comprising receiving a first request for radio frequency (RF) sensing of a target and identification information of the target, wherein the target is co-located with the UE, and wherein the first request is transmitted responsive to a triggering event determined by the UE, determining a RF sensing configuration for RF sensing the target, and transmitting to one or more base stations the RF sensing configuration for sensing the target.
Clause 17. The method of clause 16, wherein the identification information comprises: a location of the target; a speed of the target; a radar cross-section (RCS) of the target; one or more physical characteristics of the target; or any combination thereof.
Clause 18. The method of clause 16 or 17, further comprising obtaining a first location of the UE determined using a sensing result of the target.
Clause 19. The method of any of clause 16-18, wherein the sensing result of the target is determined by another UE or at least one base station of the one or more base stations.
Clause 20. The method of any of clause 16-19, further comprising: configuring the UE to communicate position reference signals (PRSs); and obtaining a second location of the UE based on measurements of the PRSs.
Clause 21. An example User Equipment (UE) for on-demand joint positioning and sensing the UE comprising one or more transceivers, one or more memories, and one or more processors communicatively coupled with the one or more transceivers and the one or more memories. The one or more processors are configured to determine a triggering event for radio frequency (RF) sensing of a target; responsive to the triggering event, determine a first request for the RF sensing of the target, determine identification information of the target, and transmit to a server, the first request along with the identification information of the target.
Clause 22. The UE of clause 21, wherein the server comprises a location server, a sensing server, or both . . . .
Clause 23. The UE of clause 21 or 22, wherein the one or more processors are further configured to determine the identification information of the target comprises determining that the target is co-located with the UE.
Clause 24. The UE of any of clauses 20-23, wherein the identification information comprises: a location of the target; a speed of the target; a radar cross-section (RCS) of the target; one or more physical characteristics of the target; or any combination thereof.
Clause 25. The UE of any of clauses 20-24, wherein the one or more processors are further configured to obtain a first location of the UE determined using a sensing result of the target.
Clause 26. The UE of any of clauses 20-25, wherein the sensing result of the target is determined by another UE.
Clause 27. The UE of any of clauses 20-26, wherein the sensing result of the target is determined by a base station.
Clause 28. The UE of any of clauses 20-27, wherein a sensing result of the RF sensing of the target comprises: a range estimation; an angle estimation; a speed estimation; a location estimation; or any combination thereof.
Clause 29. The UE of any of clauses 20-28, wherein the one or more processors are further configured to communicate with one or more network nodes, position reference signals (PRSs).
Clause 30. An example server for on-demand joint positioning and sensing a User Equipment (UE) comprising: one or more transceivers, one or more memories, and one or more processors communicatively coupled with the one or more transceivers and the one or more memories. The one or more processors are configured to receive a first request for radio frequency (RF) sensing of a target and identification information of the target, wherein the target is co-located with the UE, and wherein the first request is transmitted responsive to a triggering event determined by the UE, determine a RF sensing configuration for RF sensing the target, and transmit to one or more base stations the RF sensing configuration for sensing the target.

What is claimed is:

1. A method for on-demand joint positioning and sensing a User Equipment (UE), the method performed by the UE and comprising:
determining a triggering event for radio frequency (RF) sensing of a target;
responsive to the triggering event, determining a first request for the RF sensing of the target;
determining identification information of the target; and
transmitting to a server, the first request along with the identification information of the target.

2. The method of claim 1, wherein the server comprises a location server, a sensing server, or both.

3. The method of claim 1, wherein determining the identification information of the target comprises determining that the target is co-located with the UE.

4. The method of claim 1, wherein the identification information comprises:
a location of the target;
a speed of the target;
a radar cross-section (RCS) of the target;
one or more physical characteristics of the target; or
any combination thereof.

5. The method of claim 1, further comprising:
obtaining a first location of the UE determined using a sensing result of the target.

6. The method of claim 5, wherein the sensing result of the target is determined by another UE.

7. The method of claim 5, wherein the sensing result of the target is determined by a base station.

8. The method of claim 5, wherein a sensing result of the RF sensing of the target comprises:
a range estimation;
an angle estimation;
a speed estimation;
a location estimation; or
any combination thereof.

9. The method of claim 5, further comprising:
communicating with one or more network nodes, position reference signals (PRSs).

10. The method of claim 9, further comprising:
obtaining a second location of the UE using measurements of the PRSs.

11. The method of claim 10, wherein the second location of the UE is determined at a predetermined periodicity.

12. The method of claim 10, wherein the second location of the UE is determined in response to a second request from the server.

13. The method of claim 10, wherein responsive to a difference between the first location and the second location being larger than a predetermined threshold, the method further comprises:
transmitting a second request for terminating the RF sensing of the target.

14. The method of claim 10, wherein responsive to a difference between the first location and the second location being larger than a predetermined threshold, the method further comprises:
determining a third location of the UE using the sensing result of the target and the measurements of the PRSs.

15. The method of claim 1, further comprising:
receiving from the server assistance information, wherein the assistance information comprises:
whether the RF sensing is supported;
coverage of the RF sensing supported;
coverage per target range of the RF sensing;
target RCS of the RF sensing;
quality of service (QOS) of the RF sensing;
types of sensing result supported;
whether RF sensing-based target localization is supported;
a time window for the RF sensing;
periodicity of the RF sensing;
a speed of the target; or
any combination thereof.

16. A method for on-demand joint positioning and sensing a User Equipment (UE), the method performed by a server and comprising:
receiving a first request for radio frequency (RF) sensing of a target and identification information of the target, wherein the target is co-located with the UE, and wherein the first request is transmitted responsive to a triggering event determined by the UE;
determining a RF sensing configuration for RF sensing the target; and
transmitting to one or more base stations the RF sensing configuration for sensing the target.

17. The method of claim 16, wherein the identification information comprises:
a location of the target;
a speed of the target;
a radar cross-section (RCS) of the target;
one or more physical characteristics of the target; or
any combination thereof.

18. The method of claim 16, further comprising obtaining a first location of the UE determined using a sensing result of the target.

19. The method of claim 18, wherein the sensing result of the target is determined by another UE or at least one base station of the one or more base stations.

20. The method of claim 18, further comprising:
configuring the UE to communicate position reference signals (PRSs); and
obtaining a second location of the UE based on measurements of the PRSs.

21. A User Equipment (UE) for on-demand joint positioning and sensing the UE comprising:
one or more transceivers;
one or more memories; and
one or more processors communicatively coupled with the one or more transceivers and the one or more memories, wherein the one or more processors are configured to:
determine a triggering event for radio frequency (RF) sensing of a target;
responsive to the triggering event, determine a first request for the RF sensing of the target;
determine identification information of the target; and
transmit to a server, the first request along with the identification information of the target.

22. The UE of claim 21, wherein the server comprises a location server, a sensing server, or both.

23. The UE of claim 21, wherein the one or more processors are further configured to determine the identification information of the target comprises determining that the target is co-located with the UE.

24. The UE of claim 21, wherein the identification information comprises:
a location of the target;
a speed of the target;
a radar cross-section (RCS) of the target;
one or more physical characteristics of the target; or
any combination thereof.

25. The UE of claim 21, wherein the one or more processors are further configured to obtain a first location of the UE determined using a sensing result of the target.

26. The UE of claim 25, wherein the sensing result of the target is determined by another UE.

27. The UE of claim 25, wherein the sensing result of the target is determined by a base station.

28. The UE of claim 25, wherein a sensing result of the RF sensing of the target comprises:
a range estimation;
an angle estimation;
a speed estimation;
a location estimation; or
any combination thereof.

29. The UE of claim 25, wherein the one or more processors are further configured to communicate with one or more network nodes, position reference signals (PRSs).

30. A server for on-demand joint positioning and sensing a User Equipment (UE) comprising:
one or more transceivers;
one or more memories; and
one or more processors communicatively coupled with the one or more transceivers and the one or more memories, wherein the one or more processors are configured to:
receive a first request for radio frequency (RF) sensing of a target and identification information of the target, wherein the target is co-located with the UE, and wherein the first request is transmitted responsive to a triggering event determined by the UE;
determine a RF sensing configuration for RF sensing the target; and
transmit to one or more base stations the RF sensing configuration for sensing the target.
